(19) United States
(12) Patent Application Publication
(10) Pub. No.: US 2025/0272220 A1
(43) Pub. Date: Aug. 28, 2025

(54) COMPUTER SYSTEM COMPRISING A MICROCONTROLLER USING AN EXTERNAL MEMORY

(71) Applicant: STMicroelectronics International N.V., Geneva (CH)

(72) Inventors: Ramzi DRIDI, Ariana (TN); Dominique CHAILLOT, Pleumeleuc (FR); Patrice LE FLOCH, Rennes (FR)

(73) Assignee: STMicroelectronics International N.V., Geneva (CH)

(21) Appl. No.: 19/055,904

(22) Filed: Feb. 18, 2025

(30) Foreign Application Priority Data
Feb. 27, 2024 (FR) FR2401914

(51) Int. Cl. G06F 11/3668; G06F 13/40

(52) U.S. Cl. CPC G06F 11/3688; G06F 11/3684; G06F 13/4072

(57) ABSTRACT

A microcontroller includes: a processor, a communication interface configured to enable communication between the processor and an external memory, and an internal memory. The internal memory stores: at least one driver for controlling the communication interface when it the driver is executed by the processor, and a management software module for controlling the external memory by using the at least one driver and at least one communication parameter associated with the external memory when the driver is executed by the processor.

### PRIORITY CLAIM

This application claims the priority benefit of French Application for Patent No. 2401914, filed on Feb. 27, 2024, the content of which is hereby incorporated by reference in its entirety to the maximum extent allowable by law.

### TECHNICAL FIELD

Embodiments and implementations relate to computer systems and, more particularly, to computer systems comprising a microcontroller using an external memory.

### BACKGROUND

A microcontroller can use an external memory in order to increase its storage capacity. In particular, microcontrollers generally have an internal memory with limited capacity, or even having no non-volatile internal memory. This internal memory can be insufficient for certain applications requiring a larger storage capacity for storing data or complex programs. Thus, the use of an external memory enables the available storage capacity to be extended.

There are several types of external memories. The following types of non-volatile memories are known, in particular: “NOR Flash” or “NAND Flash”, “Random-access memory” (“RAM”), secure digital “SD” memory cards, or “microSD”.

The use of an external memory in a computer system requires a knowledge of the various memory technologies. It is important that the external memory is compatible with the microcontroller in order to ensure correct functioning and efficiency of the computer system.

In particular, it is important that the microcontroller uses a communication interface compatible with the external memory used, in order to be able to communicate with the latter. The communication interface may be a serial peripheral interface (“SPI”), in particular of the 16-line, 8-line, 4-line, 2-line or 1-line type, or an expanded Serial Peripheral Interface (“xSPI”), for example. Parallel communication interfaces also exist, in particular of the Flexible Memory Controller (“FMC”) type).

In addition, it is also important that the microcontroller uses the same communication protocol as the external memory. For example, the Joint Electron Device Engineering Council “JESD251C” protocol defines a communication protocol for an external memory using an “xSPI” communication interface.

The known solutions do not enable a microcontroller to support various types of external memories without having to specifically program the microcontroller for each type of external memory to be supported. These solutions are complex and expensive to implement.

In particular, it is possible to develop a driver suitable for an external memory that a user wishes to use with the microcontroller. Nevertheless, the development of such a driver is generally the responsibility of the user of the microcontroller (in other words the designer of the computer system including the microcontroller and the external memory), because it is this user who decides on the external memory which it is desired to use. More specifically, the manufacturer of the microcontroller cannot know in advance which external memory will be used by the user.

However, the development of such a driver can be complex for a user of the microcontroller. The cost of incorporating an external memory therefore remains with the user and not with the manufacturer of the microcontroller.

There is therefore a need in the art to provide a solution enabling the management of an external memory by a microcontroller to be simplified.

Furthermore, various development tools exist (also referred to as an Integrated Development Environment (“IDE”) enabling the user of the microcontroller to develop his application programs to be executed by the microcontroller. In particular, the development tool enables the user to load an application program on the external memory used with the microcontroller. Thus, it is important that the development tool is suitable for the type of external memory that the user wishes to use in order to be able to write data or application programs in the external memory used with the microcontroller. The same problem arises for program loading tools.

It is therefore important that each development tool incorporates an external memory loading module (or external memory loader) suitable for the requirements of this development tool as well as for the external memory that the user wishes to use. However, is not simple to develop an external memory loader for each development tool.

There is also a need to provide a solution suitable for various development tools in order to simplify the loading of an application program for a microcontroller that is able to use various types of external memory and various communication protocols.

### SUMMARY

According to one aspect, a microcontroller is proposed comprising: a processor; a communication interface configured to enable communication between the processor and an external memory; and an internal memory storing: at least one driver configured to control said communication interface when it is executed by said processor; and a management software module configured to control the external memory using said at least one driver as well as at least one communication parameter associated with said external memory when it is executed by said processor.

Such a management software module makes it possible to simplify the incorporation of an external memory in a computer system by reducing the need for knowledge of the external memory used, for a user wishing to use an external memory with a microcontroller. The use of such a management software module can therefore reduce the cost of development of drivers by a user of the microcontroller.

In addition, the control of the external memory is optimized because the management software module takes into account at least one communication parameter—in particular a plurality of communication parameters—associated with the external memory, such as a number of data lines and a maximum frequency.

Advantageously, said management software module comprises a programming interface serving as point of entry for application programs wishing to use the external memory.

This programming interface can be unique for all the external memories supported by the management module. It is thus simpler for a user to change external memory.

Preferably, said management software module includes: a driver program configured to control said external memory based on said at least one communication parameter associated with this external memory; and at least one interface program configured to enable said driver program to use said at least one driver to control said external memory.

In particular, the management software module can comprise a driver program for each type of external memory that the user of the microcontroller wishes to use.

In an advantageous embodiment, said management software module is stored in a boot area of the internal memory in such a way as to be executed by said processor during a start-up of the microcontroller.

Each communication parameter is defined as a function of the type of external memory used. For example, said at least one communication parameter associated with the external memory is chosen from a number of data communication lines, a maximum communication frequency and a latency time between write accesses and read accesses to the external memory.

Advantageously, the management software module comprises a boot program configured to enable, as a function of a defined execution mode, execution of an application program, stored in the external memory, from the external memory or even from the internal memory or from another external memory after having copied the application program there.

In an advantageous embodiment, the internal memory also stores—in particular in a volatile portion (not shown) of the internal memory—a loading software module configured to enable a development or loading tool to load an application program in the external memory using said management software module. In particular, the loading software module is loaded into the internal memory when the user wishes to load an application program in the external memory.

Such a loading software module makes it possible to establish a connection between one or more development or loading tools and the microcontroller having access to the external memory via a physical interface. In this way, the loading software module simplifies the loading of an application program in an external memory for a user. In addition, the user of the development or loading tool does not need to know the configuration of this tool or of the loading software module in order to load an application program in the external memory.

The use of such a loading software module makes it possible to benefit from the advantages provided by the management software module by optimally controlling the external memory for loading the application program. In particular, the management software module makes it possible to load the application program in the external memory using, for example, a number of data lines, a maximum frequency associated with the external memory and a latency time between write accesses and read accesses to the external memory. Thus, this makes it possible to more rapidly load the application program in the external memory.

Advantageously, the loading software module includes an executable code to enable a debug communication interface to load an application program in the external memory using said management software module.

Advantageously, the loading software module includes an executable code that can be called by a boot loader executable code to enable a boot loader communication interface to load an application program in the external memory using said management software module.

Preferably, the loading software module comprises: a programming interface configured to receive requests from the development or loading tool; and a wrapper module configured to use the management software module for loading an application program in the external memory on request from the development or loading tool.

Advantageously, the loading software module comprises a debug module configured to execute a series of tests in order to evaluate whether the loading software module is functioning correctly.

According to another aspect, a computer system is proposed, comprising an external memory and a microcontroller including: a processor; a communication interface configured to enable communication between the processor and said external memory; and an internal memory storing: at least one driver configured to control said communication interface when it is executed by said processor; and a management software module configured to control the external memory using said at least one driver as well as at least one communication parameter associated with said external memory when it is executed by said processor.

According to a further aspect, a method is proposed for managing an external memory by a microcontroller comprising execution, by a processor of the microcontroller, of a management software module stored in an internal memory of the microcontroller, the execution of the management software module resulting in control of the external memory using: at least one driver configured to control a communication interface enabling communication between the processor and the external memory; and at least one communication parameter associated with the external memory.

According to another aspect, a method is provided for loading, by a development or loading tool, of an application program in an external memory used by a microcontroller, the method comprising execution, by a processor of the microcontroller, of a loading software module, stored in an internal memory of the microcontroller, on request from the development or loading tool for loading said application program in the external memory, the loading software module using a management software module in order to control the external memory, based on: at least one driver configured to control a communication interface enabling communication between the processor and the external memory; and at least one communication parameter associated with the external memory.

According to another aspect, a code generating software tool is provided, which can be executed by a microcontroller comprising: a graphical interface suitable for allowing entry of a type of external memory to be used with a microcontroller; a code generating module suitable for generating a management software module configured to control the external memory using: at least one driver configured to control a communication interface enabling communication between a processor of the microcontroller and the external memory; and at least one communication parameter associated with the external memory.

In an advantageous implementation, the code generating module is also suitable for generating a loading software module configured to enable a development or loading tool to load an application program in the external memory using said management software module.

Advantageously, the code generating module is configured to generate the loading software module the loading software module such that it includes an executable code to enable a debug communication interface to load an application program in the external memory using said management software module.

Advantageously, the code generating module is configured to generate the loading software module such that it includes an executable code that can be called by a boot loader executable code to enable a boot loader communication interface to load an application program in the external memory using said management software module.

According to another aspect, a method for generating code that can be executed by a microcontroller is provided, the method comprising: entering, by means of a graphical interface of a code generating software tool that can be executed, of a type of external memory to be used with a microcontroller; and generating, by a code generating module of said software tool, of a management software module configured to control the external memory using: at least one driver configured to control a communication interface enabling communication between a processor of the microcontroller and the external memory, and at least one communication parameter associated with the external memory.

Advantageously, the method also comprises: generating, by said code generating module, of a loading software module configured to enable a development or loading tool to load an application program in the external memory using said management software module; and integrating, by said development or loading tool, of the loading software module and of the management software module in the internal memory of said microcontroller.

Advantageously, the generated loading software module includes an executable code to enable a debug communication interface to load an application program in the external memory using said management software module.

Advantageously, the generated loading software module includes an executable code that can be called by a boot loader executable code to enable a boot loader communication interface to load an application program in the external memory using said management software module.

### BRIEF DESCRIPTION OF THE DRAWINGS

Other advantages and features of the invention will become apparent upon examining the detailed description of non-limiting embodiments and implementations, and from the accompanying drawings, wherein:

FIG. 1 is a block diagram showing a computer system comprising a microcontroller and at least one external memory;

FIG. 2 illustrates an embodiment of an internal memory and an external memory;

FIG. 3 illustrates a software architecture in the internal memory enabling the microcontroller to use various types of external memory;

FIG. 4 is a flow diagram illustrating steps of a method for managing an external memory by a microcontroller;

FIG. 5 illustrates a software architecture used by a microcontroller to load an application program in an external memory;

FIG. 6 is a flow diagram for a method for loading, by a development or loading tool, of an application program in an external memory;

FIG. 7 is a block diagram for a computer configured to execute a software tool for generating code executable by a microcontroller using an external memory;

FIG. 8 is a flow diagram for a method for generating code executable by a microcontroller making it possible to generate a software module for managing external memory; and

FIG. 9 is a flow diagram for a method for generating code executable by a microcontroller making it possible to generate a software loading module managing external memory.

### DETAILED DESCRIPTION

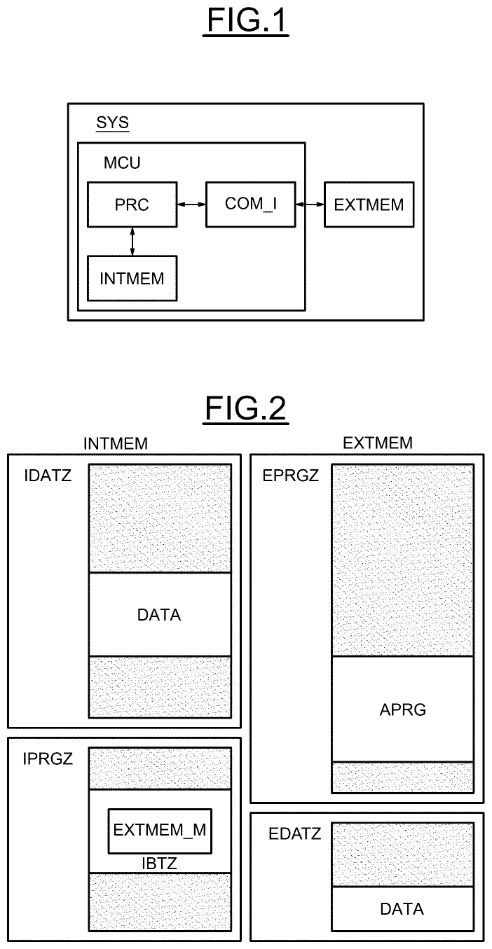

FIG. 1 shows a computer system SYS comprising a microcontroller MCU and at least one external memory EXTMEM.

The microcontroller MCU comprises an internal memory INTMEM and a processor PRC. Alternatively, the microcontroller MCU can have a plurality of processors. The microcontroller MCU can, for example, be an STM32® microprocessor, marketed by STMicroelectronics. The microcontroller MCU can comprise a processor PRC of type Arm® Cortex®-M.

The internal memory INTMEM can be a flash memory, for example.

The microcontroller MCU can comprise communication interfaces COM_I in order that the processor PRC of the microcontroller MCU can communicate with at least one external memory EXTMEM. For example, the communication interfaces COM_I can comprise an interface I_XSPI for an for expanded Serial Peripheral Interface (“xSPI”), an interface I_FMC for a flexible memory controller (“FMC”) and/or an interface I_SD/MMC for a Secure Digital (“SD”) card or a multimedia card (MMC).

The external memory EXTMEM makes it possible to extend the storage capacity of the microcontroller. The external memory can be a non-volatile memory, for example of the “NOR Flash” type. The external memory can also be a volatile memory, in particular a random access memory (“RAM”). The external memory EXTMEM can also be an “SD” card.

In the embodiment shown, the computer system SYS comprises a single external memory EXTMEM. Nevertheless, it is possible to have a computer system SYS including a plurality of external memories EXTMEM, in particular external memories of different types.

FIG. 2 illustrates an embodiment of an internal memory INTMEM and an external memory EXTMEM.

The external memory EXTMEM comprises a first space EDATZ dedicated to data storage DATA. The external memory EXTMEM also comprises a second space EPRGZ dedicated to the storage of application programs APRG.

The internal memory INTMEM comprises a first space IDATZ dedicated to data storage DATA. The internal memory INTMEM also comprises a second space IPRGZ dedicated to the storage of programs.

The internal memory INTMEM includes an area IBTZ, called a boot sector, in which a boot software called a “boot loader” is stored. The boot area IBTZ of the internal memory INTMEM also comprises a software module EXTMEM_M for management of the external memory EXTMEM.

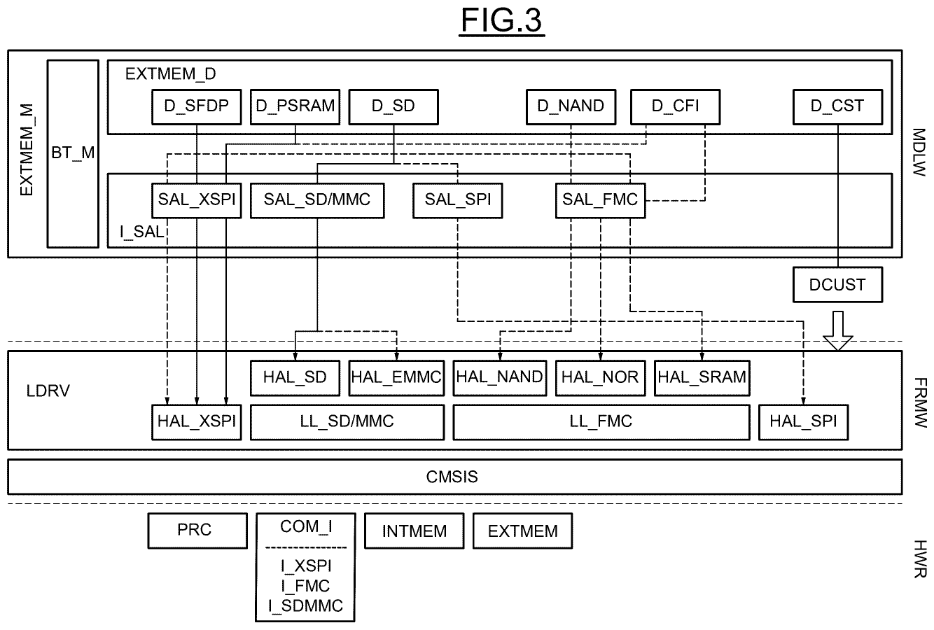

FIG. 3 illustrates a software architecture in the internal memory INTMEM, enabling the microcontroller MCU to use various types of external memory EXTMEM.

The processor PRC, the communication interface COM_I, the external memory EXTMEM and the internal memory INTMEM are shown here in a hardware layer HWR.

The software architecture is organized into a plurality of software layers.

A first software layer FRMW includes low-level programs called “firmware”. This first software layer FRMW is, in particular, configured to manage the various hardware elements of the microcontroller.

In particular, this first software layer FRMW includes a set of drivers LDRV. These drivers LDRV can be Hardware Abstraction Layer (“HAL”) drivers or Low Level (“LL”) drivers. The “HAL” and “LL” drivers can control the communication interfaces and external memories. In particular, the “HAL” and “LL” drivers can, for example, send commands to an external memory, in particular to define an operating frequency or a number of data lines for communicating with the microcontroller.

For example, these “HAL” drivers can comprise: a driver for a Serial Peripheral Interface (“SPI”), and/or a driver to control an “xSPI” bus, and/or a driver to control an “SD” card, and/or a driver to control an Embedded Multimedia Card (“EMMC”, and/or a driver to control a “NAND” flash memory, and/or a driver to control a “NOR” flash memory, and/or a driver to control a Static Random Access Memory (“SRAM”).

For example, “LL” drivers can comprise: a driver to control an “SD” card or a Multimedia Card (“MMC”), and/or a driver to control a flexible memory controller (“FMC”).

The first software layer FRMW comprises interface programs according to Common Microcontroller Software Interface Standard (“CMSIS”) which describe hardware interfaces of the microcontroller which include the communication peripherals with the external memories and all of the associated programmable registers.

A second software layer MDLW includes an intermediate level management software module EXTMEM_M, called “middleware”. This management software module EXTMEM_M is configured to initialize a communication interface COM_I and to communicate with the external memory EXTMEM. This management software module EXTMEM_M is configured to be used by application programs APRG (“software”).

The management software module EXTMEM_M includes “boot manager” programs BT_M.

These boot manager programs BT_M can be called by the application programs APRG. The boot manager programs BT_M are intended to be implemented in an execution mode of the application programs APRG stored in the external memory EXTMEM.

In particular, two execution modes can be implemented. A first execution mode enables the application programs APRG to be executed from the external memory EXTMEM. This first execution mode can be implemented when the external memory EXTMEM is associated with a predefined address that can be used by the microcontroller MCU for executing an application program APRG.

A second execution mode enables application programs APRG stored in the external memory EXTMEM to be executed from the internal memory INTMEM of the microcontroller MCU or in another external memory. In particular, this second execution mode can copy, into the internal memory INTMEM of the microcontroller (in particular in the area IDATZ of the internal memory INTMEM) or into another external memory (not shown), the application programs APRG to be executed, initially stored in the external memory EXTMEM. This second execution mode can then execute the copied application programs APRG.

During the execution of an application program APRG, the microcontroller MCU is configured to use a linker file to establish a correspondence between addresses used by an application program and memory locations where the data used by this application program are stored. This linker file depends on the execution mode used, because it provides the addresses of codes and data in external memory EXTMEM or in internal memory INTMEM.

The management software module EXTMEM_M also includes driver programs EXTMEM_D. These driver programs EXTMEM_D are configured to manage various external memory technologies EXTMEM. These driver programs EXTMEM_D are configured to control the external memory EXTMEM. These driver programs EXTMEM_D are also dependent on the standards associated with various external memory technologies EXTMEM. When no protocol is associated with an external memory EXTMEM, then the driver programs EXTMEM_D use customized communication parameters to control this external memory EXTMEM.

These driver programs EXTMEM_D can be configured to initialize a communication with the external memory EXTMEM, in particular when the external memory EXTMEM used is a serial flash memory configured to use the “SFDP” protocol (abbreviation for Serial Flash Discoverable Parameter), published under reference JESD216F.02 by the “JEDEC” (abbreviation for Joint Electron Device Engineering Council). This communication enables the driver programs EXTMEM_D to recover communication parameters associated with the external memory EXTMEM. The initialization is then carried out with minimum communication parameters, in particular using a single data line and a minimum frequency, for example of order 50 MHz.

These communication parameters can comprise an indication of the number of data lines to be used for carrying out a communication between the external memory EXTMEM and the microcontroller MCU. These communication parameters can also comprise a maximum operating frequency of the external memory EXTMEM. These communication parameters can also comprise a latency time between write accesses and read accesses to the external memory.

These communication parameters are then used by the driver programs EXTMEM_D to control the external memory EXTMEM, in particular for use of write, read and erasure commands, for data in the external memory.

For example, the driver programs EXTMEM_D comprise: a driver program D_SFDP to control an “SFDP” flash memory, in particular of the “NOR” type, and/or a driver program D_PSRAM to control a Pseudo Static Random Access Memory (“PSRAM”), a driver program D_SD to control an “SD” card, a driver program D_NAND to control a “NAND” flash memory, a driver program D_CFI to control a common flash memory interface (“CFI”), in particular of the “NOR” type, and/or optionally, a driver program D_CST for use of a customized driver DCUST configured to control an external memory not defined by a protocol.

In particular, the driver programs EXTMEM_D can support “JEDEC” protocols which define the operation of certain memories, such as serial flash memories configured to use the “SFDP” protocol.

The management software module EXTMEM_M also includes an assembly I_SAL of Software Adaptation Layer (“SAL”) interface programs. The “SAL” interface programs are configured for using “HAL” drivers, in order to control the microcontroller. The “SAL” interface programs are configured to be used by the driver programs EXTMEM_D of the management software module EXTMEM_M.

For example, the assembly I_SAL of interface program comprises: an interface program SAL_XSPI for using the driver HAL_XSPI, enabling control of an “xSPI” bus, this interface program SAL_XSPI being able to be used by the driver programs D_SFDP, D_PSRAM and D_CFI; an interface program SAL_SD/MMC for using the drivers HAL_SD and HAL_EMMC making it possible to control an “SD” card and an embedded multimedia card, this interface program SAL_SD/MMC being able to be used by the driver program D_SD; an interface program SAL_SPI for using the driver HAL_SPI making it possible to control a an “SPI” bus, this interface program SAL_SPI being able to be used by the driver program D_SD; and an interface program SAL_FMC for using the drivers HAL_NAND, HAL_NOR and HAL_SRAM, this interface program SAL_FMC being able to be used by the driver programs D_NAND, D_PSRAM, and D_CFI.

The management software module EXTMEM_M also comprises a programming interface (not shown) serving as point of entry for application programs APRG wishing to use the external memory EXTMEM. This programming interface is configured to provide functions making it possible to control the external memory EXTMEM for application programs APRG using this external memory EXTMEM.

For example, these functions can enable initializing of the external memory EXTMEM, to read, write or erase data in the external memory EXTMEM.

This programming interface is unique for the assembly of external memories EXTMEM supported by the management software module EXTMEM_M. It is thus easier for a user to change external memory EXTMEM.

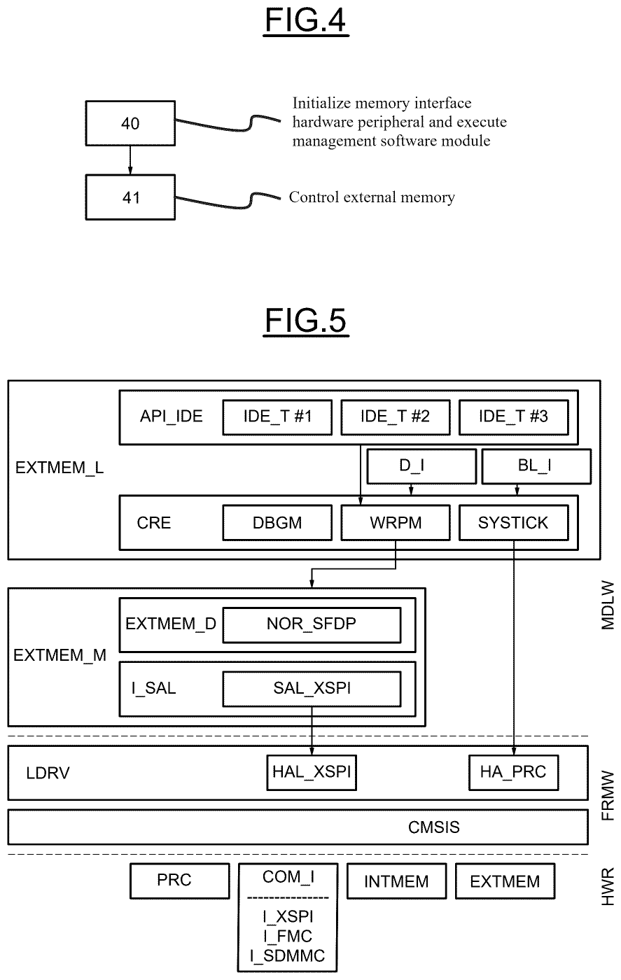

FIG. 4 illustrates an implementation of a method for managing an external memory EXTMEM by a microcontroller MCU.

The method comprises a step 40 in which the processor PRC of the microcontroller MCU initializes the memory interface hardware peripheral and executes the management software module EXTMEM_M.

The execution of the management software module EXTMEM_M leads to control 41 of the external memory EXTMEM using the driver LDRV configured to control the communication interface COM_I used for establishing a communication between the processor PRC and the external memory EXTMEM.

The control 41 of external memory EXTMEM is also exercised using at least one communication parameter associated with the external memory EXTMEM. This makes it possible to obtain better performance in the control of the external memory EXTMEM using a number of data lines and a maximum frequency associated with the external memory EXTMEM.

FIG. 5 illustrates an embodiment of a software architecture making it possible to load an application program APRG in an external memory EXTMEM used by a microcontroller MCU.

The software architecture comprises a first software layer FRMW and a second software layer MDLW such as those previously described.

In particular, the second software layer MDLW comprises a management software module EXTMEM_M as previously described. This management software module EXTMEM_M can be a second instance of the module EXTMEM_M previously described. This second instance is then uniquely dedicated to enabling the control of the external memory EXTMEM for the loading of an application program. This second instance is then stored temporarily in the internal memory INTMEM of the microcontroller MCU, in particular in a volatile part (not shown) of the internal memory INTMEM.

The second software layer also comprises a loading software module EXTMEM_L of external memory (“external memory loader”). The loading software module EXTMEM_L is configured to enable communication between various development or loading tools IDE_T (see FIG. 7) and the external memory EXTMEM in order to load an application program APRG in the external memory EXTMEM. This loading software module EXTMEM_L is then stored in the internal memory INTMEM of the microcontroller MCU, in particular in a volatile part of the internal memory INTMEM, then executed from this internal memory INTMEM in order to load the application program APRG in the external memory EXTMEM from a development tool using a point of entry of this loading software module EXTMEM_L.

In particular, the loading software module EXTMEM_L makes it possible to perform a loading of an application program of the external memory using the management software module EXTMEM_M. The loading of the external memory aims to install application programs and/or data in the external memory.

The loading software module EXTMEM_L is configured to enable the loading of an application program in the external memory EXTMEM by various development tools IDE_T (also designated by the abbreviation “IDE” for Integrated Development Environment) or by various application program loading tools.

For example, the loading software module EXTMEM_L can be used by the development tool “IAR Embedded Workbench for Arm®” (IDE_T #1), or by the development tool “Arm® Keil MDK” (IDE_T #2), or else by the development tool “STM32Cube®” (in particular “STM32CubeIDE” and “STM32CubeProg”) (IDE_T #3). The loading software module EXTMEM_L can also be used by an application program loading tool.

The loading software module EXTMEM_L can facilitate the loading of an application program APRG in various types of external memory EXTMEM and for various development tools IDE_T using the management software module EXTMEM_M.

In particular, the loading software module EXTMEM_L comprises a programming interface API_IDE serving as entry points for various development or loading tools IDE_T (IDE_T #1, IDE_T #2, IDE_T #3). The loading software module EXTMEM_L is configured to take account of the requirements of each development tool IDE_T in order to define the various points of entry.

The loading software module EXTMEM_L can also include at least one executable code serving as a point of entry for the communication interfaces of the microcontroller MCU. Such at least one executable code is stored in the internal memory INTMEM.

In particular, the loading software module EXTMEM_L can include an executable code serving as a point of entry D_I for at least one debug interface. The programming interface API_IDE of the loading software module EXTMEM_L can also include an executable code serving as a point of entry BL_I for a boot loader interface. These points of entry D_I, BL_I are used for handling the interfacing with the external memory, notably to program the external memory EXTMEM.

More particularly, the executable code serving as a point of entry D_I for the debug interface can be used by debug communication interfaces, such as an interface “SWD” (abbreviation of “Serial Wire Debug”) or an interface “JTAG” (abbreviation of “Joint Test Action Group”), to program the external memory EXTMEM.

Such loading software module EXTMEM_L allows the communication between a host (for example a development tool IDE_T) and the external memory through a debug communication interface (USART, USB, . . . , etc.).

Besides, the executable code serving as a point of entry BL_I for the boot loader interface can be used by a boot loader interface to program the external memory EXTMEM.

In particular, the boot loader has an executable code stored in the internal memory INTMEM for executing API calls for the software module EXTMEM_L, for managing the communication with a boot loader interface and for initializing the microcontroller MCU. The boot loader interface is an interface link (for example an interface USB or USART) with a host (for example a development tool IDE_T running on a computer) to download firmware to the microcontroller MCU for writing into the external memory EXTMEM. The executable code of the boot loader is stored in the internal memory INTMEM.

The executable code serving as a point of entry BL_I for the boot loader interface is configured to handle the interfacing between the boot loader interface and the external memory EXTMEM. This executable code is stored in a different zone of the internal memory INTMEM compared to the executable code of the boot loader.

API calls executed by the open bootloader allows executing the executable code serving as a point of entry BL_I for the bootloader interface. API calls are executed upon request received at the boot loader interface.

Such loading software module EXTMEM_L allows the communication between a host (for example a development tool IDE_T) and the external memory through bootloader interfaces (USART, USB, . . . , etc.).

The loading software module EXTMEM_L also includes a core CRE comprising a wrapper module WRPM. This wrapper module WRPM is configured to enable communication between a development or loading tool IDE_T and the management software module EXTMEM_M. The wrapper module WRPM therefore makes it possible to benefit from the advantages of the management software module EXTMEM_M, and thus to simplify the management of the external memory EXTMEM during loading of an application program in this external memory EXTMEM. The wrapper module WRPM leaves the user free to define his own management of access to the external memory.

In particular, this wrapper module WRPM is configured to call the functions provided by the management software module EXTMEM_M on request from the development or loading tool IDE_T.

For example, the requests from the development or loading tool IDE_T can be write, read or erase requests of the external memory. The wrapper module WRPM can then use the initialization, write, read and erase functions of the external memory provided by the management software module.

The use of such a loading software module EXTMEM_L makes it possible to profit from the advantages provided by the management software module EXTMEM_M by optimally controlling the external memory EXTMEM in order to load an application program APRG there. In particular, the management software module EXTMEM_M makes it possible to load the application program APRG in the external memory EXTMEM using the number of data lines and the maximum frequency associated with the external memory EXTMEM. This thus makes it possible to load the application program APRG in the external memory EXTMEM more quickly.

The core CRE also comprises a clock module SYSTICK configured to control the internal clock of the microcontroller. This clock module SYSTICK is configured to use an “HAL_PRC” driver of the processor of the microcontroller. This clock module SYSTICK makes it possible to simply control the internal clock of the microcontroller.

The loading software module EXTMEM_L can also comprise a debug module DBGM. This debug module DBGM is configured to execute a main function comprising a series of tests in order to evaluate whether the assembly of services of the loading software module EXTMEM_L is functioning correctly. The series of tests can comprise a write test of an item of data in the external memory EXTMEM and/or an erasure test of a sector of the external memory EXTMEM and/or an initialization test of the external memory EXTMEM and/or read test of an item of data stored in the external memory EXTMEM. This debug module DBGM is configured to call, via the wrapper module, the functions provided by the management software module DBGM. Such a debug module DBGM makes it possible to easily debug the loading software module EXTMEM_L. Such a debug module DBGM makes it possible to simplify the development of an application program APRG by enabling the user to ensure that the loading software module EXTMEM_L is functioning correctly.

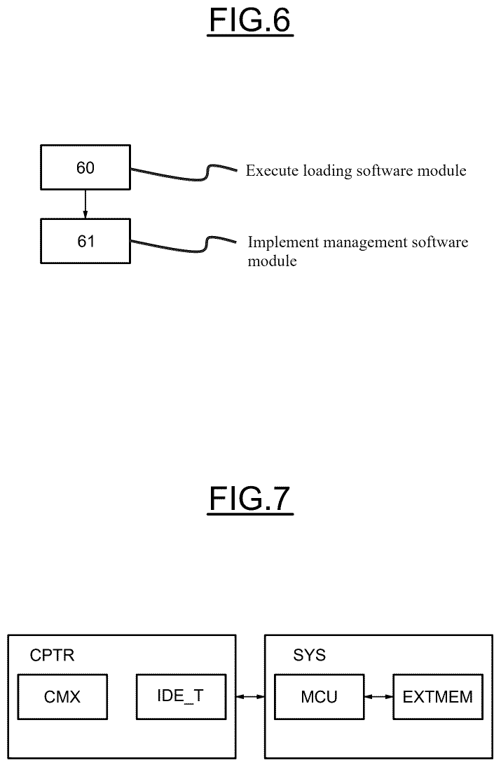

FIG. 6 illustrates an implementation of a method for loading, by a development or loading tool IDE_T, of an application program in an external memory EXTMEM used by a microcontroller MCU.

The method comprises a step 60 in which the processor PRC of the microcontroller MCU executes the loading software module EXTMEM_L, on request from the development or loading tool IDE_T for loading said application program APRG in the external memory EXTMEM. In particular, the request from the development or loading tool IDE_T is received via the programming interface API_IDE.

The execution of the loading software module EXTMEM_L by the microcontroller, on request from the development or loading tool IDE_T, leads to an implementation 61 of the management software module EXTMEM_M in order to control the external memory EXTMEM.

The control of the external memory EXTMEM is carried out by the driver LDRV configured to control the communication interface COM_I used to establish a communication between the processor PRC and the external memory EXTMEM.

The control of the external memory EXTMEM is also exercised using at least one communication parameter associated with the external memory EXTMEM.

The control of the external memory EXTMEM then makes it possible to load the application program in the external memory.

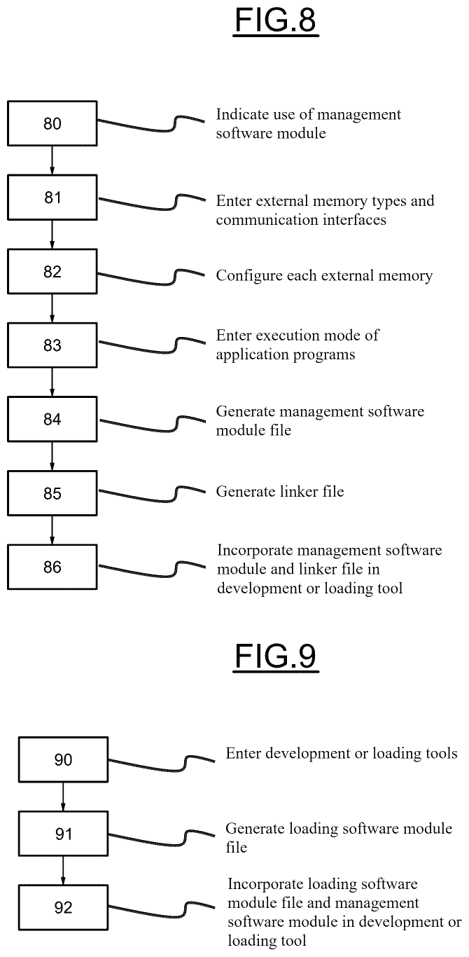

FIG. 7 illustrates a computer CPTR configured to execute a software tool CMX for generating code executable by a microcontroller MCU using an external memory EXTMEM. Such a software tool CMX for generating executable code is configured to implement the code generation processes illustrated in FIGS. 8 and 9. The computer CPTR is also configured to execute a development or loading tool IDE_T for developing and then loading an application program APRG in the external memory EXTMEM.

FIG. 8 illustrates a method for generating code executable by a microcontroller MCU making it possible to generate a software module EXTMEM_M for managing external memory as previously described.

Such a method is implemented by the software tool CMX for generating code.

The software tool CMX is configured to use a graphical interface displayed on the computer CPTR in order to enable a user to provide information concerning the external memory EXTMEM_M that he wishes to use with the microcontroller MCU.

Such a method is configured to construct the first software layer FRMW and for configuring the management software module EXTMEM_M for the adapter to the external memory EXTMEM used.

In particular, the method comprises a step 80 in which the user indicates that he wishes to use the management software module EXTMEM_M to control one or more external memories EXTMEM.

The method then comprises a step 81 in which the user enters the various types of external memories that are able be used by the microcontroller MCU. For example, the user can enter that he wishes the microcontroller to support “SFDP” memories, “PSRAM” memories or even customized memories that are not defined by a protocol.

The fact of entering the external memories to be supported, makes it possible to reduce the memory occupation of the management software module by limiting it to the external memories to be supported.

The user also enters the communication interface COM_I used for communicating with each external memory. For example, the user can enter that the communication interface used is the interface I_XSPI and/or the interface I_SD.

The method then comprises a step 82 in which the user configures each external memory EXTMEM. In particular, the user enters the driver program EXTMEM_D used to control each external memory and the configuration used for communicating with the microcontroller MCU.

If the user enters that the external memory EXTMEM will be controlled by the driver program D_SFDP corresponding to the “SFDP” driver, then the user can also enter the communication interface to be used (in particular the interface I_XSPI) and the number of data lines to be used (for example eight lines for eight-bit data).

If the user enters that the external memory EXTMEM will be controlled by the driver program D_PSRAM, then the user can also enter the communication interface to be used (in particular the interface I_XSPI) and the number of data lines to be used (for example sixteen wires for sixteen-bit data). The communication parameters are also entered by the user, such as the memory size and the maximum frequency of the memory in order to define commands and a configuration making it possible to correctly drive the external memory EXTMEM. It is also possible to define commands to control the external memory.

The method then comprises a step 83 in which the user enters the execution mode of the application programs. In particular, the user can choose said first execution mode, in which the application programs are executed from the external memory, or else said second execution mode, in which the application programs are executed from the internal memory INTMEM of the microcontroller or from another external memory enabling an execution of programs (for example a “PSRAM” external memory) after having been copied there.

The method then comprises a step 84 of generating a file corresponding to the management software module EXTMEM_M as previously described in relation to FIG. 1, by taking into account the information entered by the user.

The method also comprises a step 85 in which the software tool CMX for generating code generates a linker file suitable for the management software module EXTMEM_M according to the microcontroller and the development or loading tool IDE_T used. The linker file enables a correspondence to be established between addresses used by an application program APRG and memory locations where the data used by this application program are stored.

The method then comprises a step 86 in which the management software module EXTMEM_M and the linker file are incorporated in a development or loading tool IDE_T. In this way, this development or loading tool can then incorporate the management software module EXTMEM_M in the boot area of the internal memory INTMEM of the microcontroller.

FIG. 9 illustrates a method for generating code executable by a microcontroller MCU making it possible to generate a software loading module EXTMEM_L managing external memory as previously described.

Such a method is implemented by the software tool CMX for generating code.

The software tool CMX is configured to use a graphical interface displayed on a computer CPTR for enabling a user to provide the requested information.

The method first comprises a step 90 in which the user enters the one or more development or loading tools IDE_T that he wishes to use with the software tool CMX.

The method then comprises a step 91 in which the software tool CMX generates a file corresponding to the loading software module EXTMEM_L from development or loading tools IDE_T entered by the user. In particular, the software tool CMX defines the points of entry of the loading software module EXTMEM_L (in other words the programming interfaces API_IDE) for the development tools IDE_T. The software tool CMX also generates a second instance of the file corresponding to the management software module EXTMEM_M as previously described.

The method then comprises a step 92 in which the file corresponding to the loading software module EXTMEM_L and the second instance of the management software module EXTMEM_M are incorporated in a development or loading tool IDE_T among those previously entered by the user. In this way, this development or loading tool can then incorporate the loading software module EXTMEM_L and the second instance of the management software module EXTMEM_M in the internal memory INTMEM of the microcontroller. The development or loading tool can then use a point of entry of the loading software module EXTMEM_L for loading an application program in the external memory EXTMEM of the microcontroller.

1. A microcontroller, comprising:
a processor;
a communication interface configured to enable communication between the processor and an external memory;
an internal memory configured to store:
at least one driver configured to control said communication interface when the at least one driver is executed by said processor; and
a management software module configured to control the external memory by using said at least one driver and at least one communication parameter associated with said external memory when the at least one driver is executed by said processor.

2. The microcontroller according to claim 1, wherein said management software module comprises a programming interface serving as a point of entry for application programs wishing to use the external memory.

3. The microcontroller according to claim 1, wherein said management software module includes:
a driver program configured to control said external memory based on said at least one communication parameter associated with the external memory; and
at least one interface program configured to enable said driver program to use said at least one driver to control said external memory.

4. The microcontroller according to claim 1, wherein said management software module is stored in a boot area of the internal memory and is executed by said processor during a start-up of the microcontroller.

5. The microcontroller according to claim 1, wherein said at least one communication parameter associated with the external memory comprises a chosen one of: a number of data communication lines, a maximum communication frequency and a latency time between write accesses and read accesses to the external memory.

6. The microcontroller according to claim 1, wherein the management software module comprises a boot program configured to enable, according to a defined execution mode, execution of an application program that is: stored in the external memory, from the external memory or from the internal memory or from another external memory after having copied the application program there.

7. The microcontroller according to claim 1, wherein the internal memory further stores a loading software module configured to enable a development or loading tool to load an application program in the external memory using said management software module.

8. The microcontroller according to claim 7, wherein the loading software module includes an executable code to enable a debug communication interface to load an application program in the external memory using said management software module.

9. The microcontroller according to claim 7, wherein the loading software module includes an executable code that can be called by a boot loader executable code to enable a boot loader communication interface to load an application program in the external memory using said management software module.

10. The microcontroller according to claim 7, wherein the loading software module comprises a debug module configured to execute a series of tests in order to evaluate whether the loading software module is functioning correctly.

11. The microcontroller according to claim 7, wherein the loading software module comprises:
a programming interface configured to receive development or loading tool requests; and
a wrapper module configured to use the management software module for loading an application program in the external memory on request from the development or loading tool.

12. The microcontroller according to claim 11, wherein the loading software module comprises a debug module configured to execute a series of tests in order to evaluate whether the loading software module is functioning correctly.

13. A computer system, comprising an external memory and a microcontroller including:
a processor;
a communication interface configured to enable communication between the processor and said external memory; and
an internal memory storing:
at least one driver configured to control said communication interface when the at least one driver is executed by said processor,
a management software module configured to control the external memory by using said at least one driver and at least one communication parameter associated with said external memory when the at least one driver is executed by said processor.

14. A method for managing an external memory by a microcontroller, comprising:
executing, by a processor of the microcontroller, a management software module stored in an internal memory of the microcontroller;
wherein executing the management software module results in control of the external memory using:
at least one driver configured to control a communication interface enabling communication between the processor and the external memory, and
at least one communication parameter associated with the external memory.

15. A method for loading, by a development or loading tool, an application program in an external memory used by a microcontroller, the method comprising:
executing, by a processor of the microcontroller, a loading software module, stored in an internal memory of the microcontroller, on request from the development or loading tool for loading said application program in the external memory;
wherein the loading software module uses a management software module in order to control the external memory based on:
at least one driver configured to control a communication interface enabling communication between the processor and the external memory, and
at least one communication parameter associated with the external memory.

16. A code generation software tool configured for execution by a microcontroller, comprising:
a graphical interface configured to allow entry of a type of external memory to be used with a microcontroller; and
a code generating module configured to generate a management software module configured to control the external memory using:
at least one driver configured to control a communication interface enabling communication between a processor of the microcontroller and the external memory, and
at least one communication parameter associated with the external memory.

17. The software tool according to claim 16, wherein the code generating module is further configured to generate a loading software module configured to enable a development or loading tool to load an application program in the external memory using said management software module.

18. The software tool according to claim 17, wherein the code generating module is configured to generate the loading software module the loading software module such that it includes an executable code to enable a debug communication interface to load an application program in the external memory using said management software module.

19. The software tool according to claim 17, wherein the code generating module is configured to generate the loading software module such that it includes an executable code that can be called by a boot loader executable code to enable a boot loader communication interface to load an application program in the external memory using said management software module.

20. A method for generating code executable by a microcontroller, the method comprising:
entering a type of external memory to be used with a microcontroller using a graphical interface of a code generating software tool that can be executed; and
generating a management software module configured to control the external memory, by a code generating module of said code generating software tool, using:
at least one pilot configured to control a communication interface enabling communication between a processor of the microcontroller and the external memory, and
at least one communication parameter associated with the external memory.

21. The method according to claim 20, further comprising:
generating, by said code generating module, a loading software module configured to enable a development or loading tool to load an application program in the external memory using said management software module; and
incorporating, by said development or loading tool, the loading software module and of the management software module in the internal memory of said microcontroller.

22. The method according to claim 21, wherein the generated loading software module includes an executable code to enable a debug communication interface to load an application program in the external memory using said management software module.

23. The method according to claim 21, wherein the generated loading software module includes an executable code that can be called by a boot loader executable code to enable a boot loader communication interface to load an application program in the external memory using said management software module.
